(19) United States
(12) Patent Application Publication
(10) Pub. No.: US 2006/0218794 A1
(43) Pub. Date: Oct. 5, 2006

(54) Razor cartridge

(75) Inventors: Jay Bunnell, Orange, CT (US); Stephan Fischer, Gevelsberg (DE); Michael O'Malley, Southport, CT (US); Thomas A. Follo, Milford, CT (US); Paul D. Richard, Shelton, CT (US); Jochen Thoene, Wuppertal (DE)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/399,056

(22) Filed: Apr. 5, 2006

Related U.S. Application Data
(60) Provisional application No. 60/668,824, filed on Apr. 5, 2005.
(60) Provisional application No. 60/668,760, filed on Apr. 5, 2005.

(51) Int. Cl. B26B 19/28

(52) U.S. Cl. 30/44

(57) ABSTRACT

According to the present invention, a razor cartridge includes at least three parallel razor blades, the three blades including a first blade adjacent a guard that is forward of the blades, a last blade adjacent a cap that is aft of the blades, and at least one middle blade positioned between the first and last blades; wherein the guard includes a skin-stretching member, and a lubricating strip that is located between the skin-stretching member and the blades, the skin-stretching member including a single, continuous protrusion that extends at least part way across the guard.

### CROSS REFERENCE TO RELATED APPLICATIONS

This application is entitled to the benefit of and incorporates by reference the disclosure of U.S. Patent Application 60/668,824 filed on Apr. 5, 2005, entitled “Razor Cartridge.”

### BACKGROUND OF THE INVENTION

1. Field of the Invention

The present invention relates generally to shaving implements, and, more particularly, to a razor cartridge for use with a shaving implement.

2. Description of the Prior Art

Modern shaving implements can include a plurality of blades disposed within a razor cartridge. The razor cartridge is, in turn, mounted on a handle during use. Some safety razors have a disposable razor cartridge that is selectively detachable to a reusable handle, while others have a handle and a razor cartridge that are manufactured as a single, disposable unit.

It also is known to place certain powered devices, such as a motorized spinning eccentric weight that cause the shaving implement to vibrate, inside the handle. The motorized eccentric spinning weight can provide numerous advantages to the shaving implement, such as, but not limited to, providing a closer shave.

The razor cartridge typically includes one or more blades, a guard forward of the blades, and a cap aft of the blades. Typically, the guard is operable to stretch the surface being shaved prior to encountering the one or more blades, and the blades are operable to shave the unwanted hair from a surface, and the cap typically includes a lubricating strip that has post-shave benefits.

One problem associated with razor cartridges is associated with the guard. Most guards typically function only to pre-stretch the surface being shaved, but provide few comfort benefits. It is known, however, to place a lubricating (or comfort) strip forward of the one or more blades and aft of a skin-stretching member in order to lubricate, medicate, or otherwise treat the skin prior to shaving. However, such guards to date are too large because the skin-stretching member includes numerous protrusions. The comfort strip and numerous protrusions can make the razor cartridge difficult to use in certain instances (e.g., in tight locations).

Another problem associated with razor cartridges is associated with the blades. For example, the distance between the blades (i.e., the “inter-blade span”, which is measured in the shaving direction across the razor cartridge along a straight line between the sharpened cutting edges of neighboring blades) has an effect on safety, comfort and rinsability of the razor cartridge. In general, reducing the inter-blade span increases shaving comfort because a smaller skin bulge enters into the gap between adjacent blades during normal shaving. However, on the other hand, reducing the inter-blade span between blades typically has a negative impact on the rinsability of the razor cartridge. In general, the smaller the span between the blades, the more debris that tends to collect therein.

In addition, blade exposure is an important factor that relates directly to the comfort and safety of a razor cartridge. Blade exposure, for the purposes of the present application, is defined to be the perpendicular distance or height (positive or negative) of the cutting edge of the blade being measured with respect to a plane tangential to the outermost surface of the skin-engaging feature immediately in front of, and immediately aft of the edge.

Therefore, there is a need in the art to provide a razor cartridge for use with an associated handle that decreases the inter-blade span of the blades disposed in the razor cartridge in order to increase comfort, without limiting rinsability. In addition, there is also a need to provide a razor cartridge having a guard that provides comfort benefits without sacrificing maneuverability of the razor.

It is, therefore, an object of the present invention to overcome the known shortcomings of the prior art.

### SUMMARY OF THE DISCLOSURE

According to the present invention, a razor cartridge includes at least three (3) razor blades, a guard, a cap, and a rinse-through gap. The guard is located forward of the blades and includes a skin-stretching member and a lubricating strip. The skin-stretching member includes a single, continuous protrusion that extends across at least a portion of the guard. The blades are substantially parallel to one another and include a first blade adjacent the guard, a last blade adjacent the cap, and at least one middle blade between the first and last blades. The first blade has an exposure of zero or less. The at least one middle blade between the first blade and the last blade have exposure(s) of approximately zero, and the last blade has an exposure greater than zero. The first blade is approximately 1.3 mm aft of the guard. The remaining blades (i.e., the last blade and the at least one middle blade positioned between the first and last blades) have inter-blade spans of approximately 1.0 mm, or less. The cap includes at least one lubricating strip. The rinse-through gap allows water to pass between the blades, rinsing any debris from there between.

According to one aspect of the present invention, the razor cartridge is mounted on a handle having a vibration mechanism therein.

According to another aspect of the present invention, the rinse-through gap is substantially parallel to the at least three (3) blades.

According to a further aspect of the present invention, the razor cartridge includes four (4) blades.

One advantage of the present invention is that the blades have reduced inter-blade spans, and therefore allow a smaller skin bulge of the surface being shaved to enter into the gap between adjacent blades. The smaller skin bulge reduces the friction between the surface being shaved and the blades, resulting in a more comfortable shave.

Another advantage of the present invention that the razor cartridge is selectively attached to a handle that vibrates. In addition to providing a more comfortable shave, the vibrating handle also tends to loosen debris (when rinsing out the razor cartridge), such as hair follicles, that may become lodged between the blades during shaving. Therefore, despite the reduced inter-blade spans, the razor cartridge is unlikely to be adversely affected by a build-up of debris between the blades.

A further advantage of the present invention is the combination of the lubricating strip and the skin-stretching member on the guard bar. The lubricating strip treats the skin prior to being shaved, providing for a more comfortable shave. In addition, the skin-stretching member of the guard bar includes a single protrusion that extends across the guard. Therefore, the guard pre-stretches and lubricates the skin without being overly large, and difficult to maneuver in tight areas.

These and other advantages of the present invention will be apparent to one skilled in the art in light of the FIGS, Detailed Description, and Claims.

### BRIEF DESCRIPTION OF THE DRAWINGS

FIG. 1 is a perspective view of one embodiment of the present invention;

FIG. 2 is a sectional view of FIG. 1 along line 2-2;

FIG. 3 is a perspective view of one embodiment of the razor cartridge of the present invention;

FIG. 4 is a front view of one embodiment of the razor cartridge of the present invention;

FIG. 5 is a sectional view of FIG. 4 along line 5-5;

FIG. 5A is a sectional view of one embodiment of a razor cartridge having blades mounted on blade supports;

FIG. 6 is a diagrammatic view of one embodiment of the guard of the razor cartridge of the present invention;

FIG. 6A is a diagrammatic view of one embodiment of the guard of the razor cartridge of the present invention;

FIG. 6B is a diagrammatic view of one embodiment of the guard of the razor cartridge of the present invention;

FIG. 6C is a diagrammatic view of one embodiment of the guard of the razor cartridge of the present invention;

FIG. 6D is a diagrammatic view of one embodiment of the guard of the razor cartridge of the present invention; and

FIG. 6E is a diagrammatic view of one embodiment of the guard of the razor cartridge of the present invention.

### DETAILED DESCRIPTION

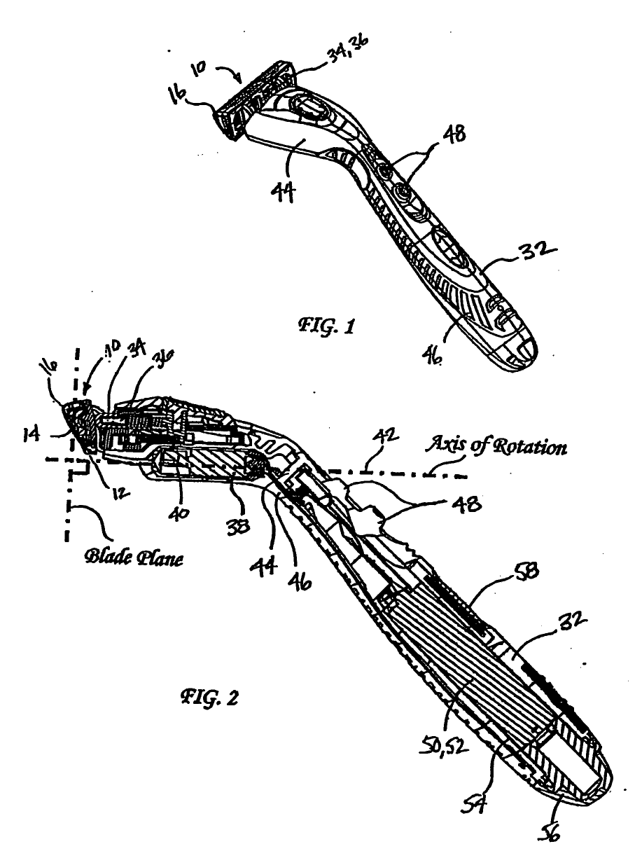

Referring to FIGS. 1-3, the razor cartridge 10 of the present invention includes a guard 12, at least three (3) blades 14, and a cap 16. The guard 12 is located forward of the blades 14 and includes a skin-stretching member 18 and a lubricating (or comfort) strip 20. The skin-stretching member 18 includes a single, continuous protrusion 22 that extends across at least a portion of the guard 12. The blades 14 are substantially parallel to one another and include a first blade 24 adjacent the guard 12, a last blade 26 adjacent the cap 16, and at least one middle blade 28 between the first and last blades 24, 26. In addition, each blade 14 defines a blade plane, as shown in FIG. 2. The cap 16 includes at least one comfort strip 20. A rinse-through gap 30 extends between the guard 12 and cap 16 and between the blades 14 (FIGS. 5 and 5A). Therefore, when rinsing out the razor cartridge 10 of the present invention, the rinse-through gap 30 allows water to pass between the blades 14, rinsing any debris from there between.

In some embodiments, the razor cartridge 10 is coupled to a handle 32. The razor cartridge 10 can be coupled in a manner such that the razor cartridge 10 is selectively detachable from the handle 32, or, in other instances, the razor cartridge 10 may not be intended to be detached from the handle 32 during normal use. In both types of embodiments, the razor cartridge 10 may be fixedly or pivotally attached to the handle 32. In addition, the handle 32 may further include a biasing member 34 that is operable to urge the razor cartridge 10 toward a rest position (see FIG. 2). In some embodiments the biasing member 34 is a spring-loaded plunger 36; however, any type of biasing member 34 known to those in the art may be utilized. The biasing member 34 is movable between an extended position (when the razor cartridge 10 is in a rest position), and a retracted position (when the razor cartridge 10 is pivoted relative to handle 32 when, for example, forces that occur during normal shaving are placed on the razor cartridge 10). Once the forces are no longer acting on the razor cartridge 10, the biasing member 34 returns the razor cartridge 10 to the rest position.

In some instances, the razor handle 32 includes a vibration mechanism 38 capable of vibrating the razor cartridge 10, as shown in FIG. 2. In these embodiments, the vibration mechanism 38 is preferably a motorized spinning eccentric weight 40. A spinning eccentric weight causes vibrations in a plane substantially perpendicular to the axis 42 about which the eccentric weight spins 40 (See FIG. 2, which indicates the axis of rotation). The vibration mechanism 38 may be positioned in the handle 32 in any suitable manner; however, it is preferable that the vibration mechanism 38 be completely encased between a first and second injection molded portions 44, 46 (e.g., the vibration mechanism 38 is secured to a first molded portion 44, then a second molded portion 46 is molded onto the first molded portion 44, encasing the vibration mechanism between the first and second molded portions 44, 46). Preferably, the vibration mechanism 38 is oriented in (or on) the handle 32 such that the axis 42 about which the eccentric weight 40 spins is substantially perpendicular to the blade plane of at least one blade 14 (see e.g., FIG. 2). Therefore, when the vibration mechanism 38 is turned on, the vibrations cause at least one of the blades 14 to vibrate in the blade plane. The action of a blade 14 vibrating in the blade plane results in the blade 14 making a “chopping” motion. The chopping motion effectively reduces the cut force of the blade 14. Reducing the cut force generally provides a more comfortable shave.

In addition, the handle typically includes a switch 48 that is operable to activate and deactive the vibration mechanism 38. The switch 48 and the vibration mechanism 38 are typically connected in a circuit that includes a power source 50, such as a battery 52. The battery 52 may be housed in a cavity 54 in the handle (see e.g., FIG. 2) that is selectively accessible via a removable cap 56. Alternatively, the battery 52 can also be encased within the outer surface 58 of the handle 32.

The cap 16 is located aft of the blades 14 and includes a lubricating strip 20. The lubricating strip 20, also often referred to as a comfort strip, can include any shaving aid known in the art. Shaving aids include any material that lubricates, medicates, or otherwise advantageously treats the surface being shaving before, during, or after the shaving process.

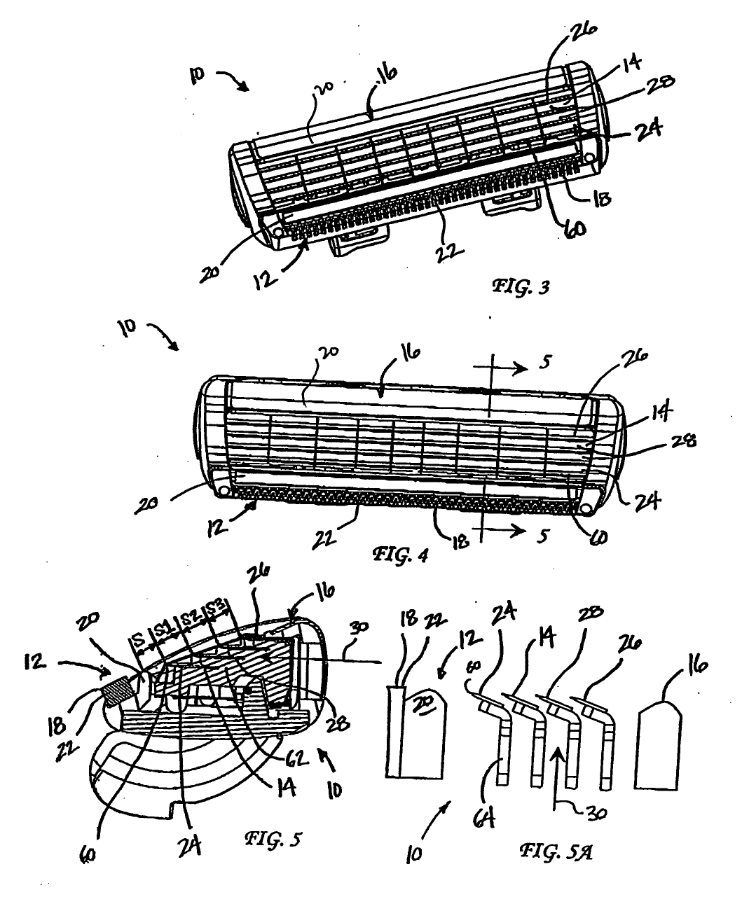

Referring to FIGS. 3-5A, the razor cartridge 10 of the present invention includes at least three (3) blades 14, and preferably four (4) blades 14. Each razor blade 14 includes a sharpened cutting edge 60, and, as discussed above, defines a blade plane, as shown in FIG. 2. Preferably, the blades 14 are mounted in the razor cartridge 10 in a manner such that the blade plane of each blade 14 is parallel to the blade planes of each of the other blades 14.

In some embodiments, the blades 14 of the present invention are positioned in the razor cartridge 10 such that the span (“S”) between the first blade 24 and guard 12 is approximately 1.3 mm, and the inter-blade spans (“S1”, “S2”, etc.) between the remaining blades 14 (as shown in FIG. 5) is approximately 1.0 mm. (Note: the span (“S”) between the first blade 24 and the guard 12 is determined by measuring the length of a straight line drawn tangential to the guard 12 and the cutting edge 60 of the first blade 24 aft of the guard 12). In addition, the first blade 24, in some embodiments has an exposure of zero or less (preferably, between zero and approximately −0.03 mm). The last blade 26 has an exposure that is positive, and preferably between zero and 0.03 mm. Each of the blades 14 between the first and last blades 24, 26 preferably has an exposure of approximately zero.

Referring now to FIGS. 5 and 5A, the blades 14 may be manufactured from any suitable material; however, stainless steel has proven to have particular utility. Typically, the blades 14 are flexible, and therefore, must be at least partially supported when positioned within the razor cartridge 10. The blades 14 of the present invention may be supported in any suitable manner. For example, in some embodiments, such as the one shown in FIG. 5, the blades 14 may be supported at various points along the blade 14 by cartridge material 62. Alternatively, in some embodiments, the blades 14 may include a dedicated blade support 64 (e.g., a bent piece of metal) that is affixed (e.g., welded at various locations) to the blade 14 before insertion into the razor cartridge 10. In the former example (i.e., in embodiments where the blades 14 are supported by cartridge material 62), the rinse-through gaps 30 typically extend between the guard 12 and the cap 16, and are oriented in a direction generally parallel to the blade plane of one or more of the blades 14, as shown in FIG. 5. In the latter example, (i.e., in embodiments where the blades 14 have a dedicated blade support 64 secured thereto), the rinse-through gaps 30 typically extend between the guard 12 and the cap 16, and are oriented at an angle relative to the blade plane of one or more blades 14, as shown in FIG. 5A.

The guard 12 is located forward of the blades 14 and includes a skin-stretching member 18 and a lubricating strip 20. The skin-stretching member includes a single, continuous protrusion 22 that extends across at least a portion of the guard 12. In other words, the surface being shaved passes over the skin-stretching member 18, when moving in the shaving direction, a single time. Put another way, if a cross-section of the guard 12 is taken in a plane parallel to the shaving direction at any location across the guard 12, the protrusion 22 of the skin-stretching member 18 will be cut no more than a single time.

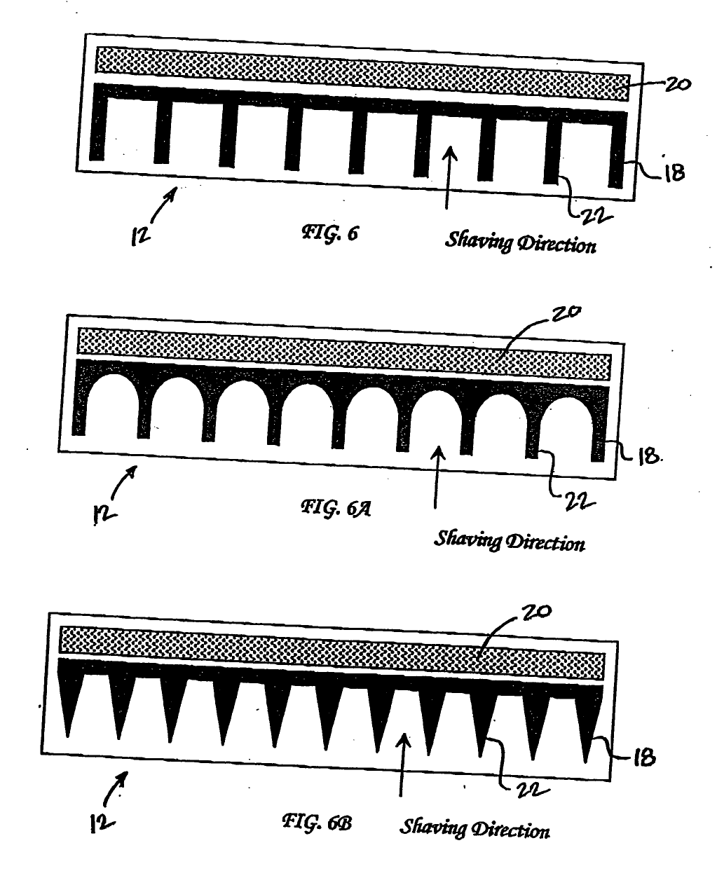

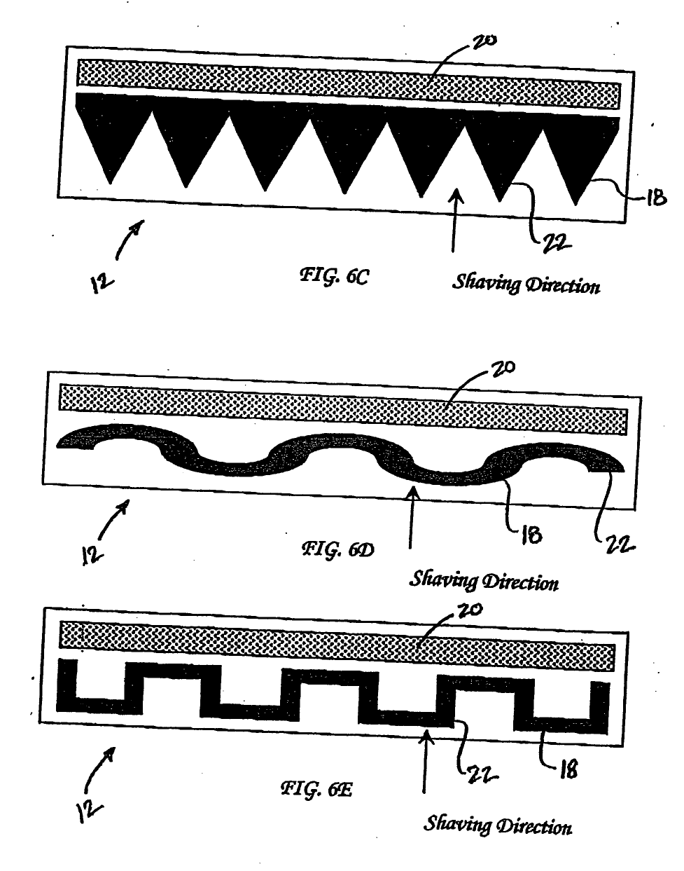

The preferred design of the protrusion 22 of the skin-stretching member 18, a zig-zag pattern, is shown in FIGS. 3 and 4; however, any of the protrusion 22 designs shown in FIGS. 6-6E are suitable. In embodiments having a repeating design, as is the case in all of FIGS. 6-6E, the pattern may repeat as frequently, or infrequently as desired; however, it is preferably that the preferred pattern shown in FIGS. 3 and 4 repeat approximately 10-15 times per centimeter. In addition, in order to prevent the guard 12 from becoming too large, and consequently, difficult to maneuver when shaving in tight areas, it is preferable that the skin-stretching portion 18 extend no more than approximately 1 mm in the shaving direction.

In addition, the guard 12 includes a lubricating, or comfort, strip 20 that is aft of the skin-stretching member 18, but forward of the blades 14. The comfort strip 20 may include one or more shaving aids that lubricates, medicates, or otherwise advantageously treats the surface being shaving before, during, or after the shaving process.

It is also preferable that the lubricating strip 20 not extend too far in the shaving direction, which would make the guard too large, and difficult to maneuver. Rather, it is preferable that the lubricating strip 20 extend no more than approximately 1.5 mm in the shaving direction.

In assembly, and now referring to FIG. 1, the razor cartridge 10 of the present invention is, in some instances, coupled to a handle 32 having a vibration mechanism 38 therein. In use, the user selectively activates the vibration mechanism 38, causing the handle 32, razor cartridge 10, and associated blades 14 to vibrate in the blade plane of at least one blade 14. The user then shaves the desired surface of unwanted hair. During the shaving process, the user can selectively rinse the collected debris from between the blades 14 by rinsing water through the rinse-through gaps that are, in some embodiments, parallel to the blade plane of at least one blade, and/or submerging the razor cartridge (while the handle 32 continues vibrating) under water. When submerged, the vibrating handle 32 tends to force water through the rinse-through gaps 30 and dislodges any collected debris. Once the blades 14 are clear of debris, the user may selectively continue to shave the desired surface. Upon completion, the user deactivates the vibration mechanism 38 and stores the razor cartridge 10 of the present invention, and its associated handle 32.

Modification and variations may be made to the disclosed embodiments without departing from the subject and spirit of the invention as defined by the following claims.

What is claimed is:

1. A razor cartridge, comprising:
at least three parallel razor blades, the three blades including a first blade adjacent a guard that is forward of the blades, a last blade adjacent a cap that is aft of the blades, and at least one middle blade positioned between the first and last blades;
wherein the guard includes a skin-stretching member, and a lubricating strip that is located between the skin-stretching member and the blades, the skin-stretching member including a single, continuous protrusion that extends at least part way across the guard.

2. The razor cartridge of claim 1, wherein there is a span of approximately 1.3 mm between the guard and the first blade aft of the guard and wherein there is an inter-blade span of approximately 1.0 mm between each of the remaining blades.

3. The razor cartridge of claim 1, wherein the razor cartridge includes a rinse-through gap that extends generally perpendicular to a blade plane defined by at least one of the blades.

4. The razor cartridge of claim 1, wherein the first blade adjacent the guard has an exposure equal to or less than zero; wherein the last blade adjacent the cap has an exposure of greater than zero; and wherein each of the remaining blades has an exposure of approximately zero.

5. The razor cartridge of claim 1, wherein the continuous protrusion forms a repeating pattern.

6. The razor cartridge of claim 5, wherein the repeating pattern is a zig-zag pattern.

7. The razor cartridge of claim 5, wherein the repeating pattern repeats approximately ten to fifteen times per centimeter.

8. The razor cartridge of claim 1, wherein the skin stretching portion extends no more than approximately 1 mm in the shaving direction.

9. The razor cartridge of claim 1 wherein the lubricating strip extends no more than approximately 1.5 mm in the shaving direction.

10. A razor cartridge, comprising:
at least three parallel razor blades, the three blades including a first blade adjacent a guard that is forward of the blades, and a last blade adjacent a cap that is aft of the blades; and
a razor handle coupled to the razor cartridge, the razor handle having a vibrating mechanism therein that is operable to vibrate the handle and razor cartridge during normal shaving;
wherein the guard includes a skin-stretching member, and a lubricating strip that is located between the skin-stretching member and the blades, the skin-stretching member including a single, continuous protrusion that extends at least part way across the guard.

11. The razor cartridge of claim 10, wherein there is a span of approximately 1.3 mm between the guard and the first blade aft of the guard and wherein there is a inter-blade span of approximately 1.0 mm between the each of the remaining blades.

12. The razor cartridge of claim 10, wherein the razor cartridge includes a rinse-through gap that extends generally perpendicular to a blade plane defined by at least one of the blades.

13. The razor cartridge of claim 10, wherein the first blade adjacent the guard has an exposure equal to, or less than zero; wherein the last blade adjacent the cap has an exposure of greater than zero; and wherein each of the remaining blades has an exposure of approximately zero.

14. The razor cartridge of claim 10, wherein the continuous protrusion forms a repeating pattern.

15. The razor cartridge of claim 14, wherein the repeating pattern is a zig-zag pattern.

16. The razor cartridge of claim 14, wherein the repeating pattern repeats approximately ten to fifteen times per centimeter.

17. The razor cartridge of claim 10, wherein the skin stretching portion extends no more than approximately 1 mm in the shaving direction.

18. The razor cartridge of claim 10 wherein the lubricating strip extends no more than approximately 1.5 mm in the shaving direction.

19. The razor cartridge of claim 10, the razor handle having a biasing member operable to urge the razor cartridge toward a rest position, the biasing member being movable between an extended position and a retracted position in response to forces acting on the razor cartridge.

20. The razor cartridge of claim 19, wherein the biasing member is a spring loaded plunger.

21. The razor cartridge of claim 10, wherein the vibration mechanism is a motorized spinning eccentric weight.

22. The razor cartridge of claim 21, wherein the motorized spinning eccentric weight causes vibrations in a plane substantially perpendicular to an axis about which the eccentric weight spins.

23. The razor cartridge of claim 10, wherein the vibration mechanism is completely encased between a first injection molded portion and a second injection molded portion.

24. The razor cartridge of claim 10, including a switch operable to activate and deactivate the vibration mechanism, circuit and a power source.

25. The razor cartridge of claim 24, wherein the power source is a battery, the battery being housed in a cavity within the handle.
